(19) United States
(12) Patent Application Publication
(10) Pub. No.: US 2024/0407890 A1
(43) Pub. Date: Dec. 12, 2024

(54) DENTAL SCREW FOR OSSEOINTEGRATION OF BONE SURFACE

(71) Applicant: E- WIRELIGNER CO., LTD., Jeollabuk-do (KR)

(72) Inventor: Youn Sic Chun, Seoul (KR)

(73) Assignee: E- WIRELIGNER CO., LTD., Jeollabuk-do (KR)

(21) Appl. No.: 18/364,632

(22) Filed: Aug. 3, 2023

(30) Foreign Application Priority Data
Jun. 9, 2023 (KR) 10-2023-0074017

(51) Int. Cl. A61C 7/36

(52) U.S. Cl. CPC A61C 7/36

(57) ABSTRACT

A dental screw for osseointegration of a bone surface includes a base including a plurality of penetrating bodies, wherein the plurality of penetrating bodies includes a first piercing surface inclined at a first angle with respect to a second base surface in a first circumferential direction of an edge of the second base surface of the base, a second piercing surface inclined at a second angle with respect to the second base surface in a second circumferential direction of the edge of the second base surface, the second circumferential direction being opposite to the first circumferential direction, a plurality of side piercing surfaces between the first piercing surface and the second piercing surface, and a tip formed between the first piercing surface, the second piercing surface, and the plurality of side piercing surfaces, and wherein the second angle may be greater than the first angle.

### CROSS-REFERENCE TO RELATED APPLICATION

This application claims the benefit of Korean Patent Application No. 10-2023-0074017 filed on Jun. 9, 2023, in the Korean Intellectual Property Office, the entire disclosure of which is incorporated herein by reference for all purposes.

### BACKGROUND

### 1. Field of the Invention

The disclosure generally relates to a dental screw, and for example, to a dental screw configured to be bonded to a bone surface by osseointegration.

### 2. Description of the Related Art

An orthodontic anchoring device, which is used by being fixed to a bone within oral tissue, is being developed. Adhesion is crucial for this anchoring device to be securely fixed to the bone, and different types of dental screws may be used to ensure strong adhesion and prevent loosening. For example, Korean Patent Application Publication KR 10-2020-0112499 A discloses an orthodontic anchoring device and system. The above description is information acquired during the course of conceiving the present disclosure, or already possessed at the time, and is not necessarily art publicly known before the present application was filed.

### SUMMARY

Embodiments provide a dental screw that is stably maintained on a bone surface. Embodiments provide a dental screw that increases the probability of osseointegration with a bone surface.

According to an aspect, there is provided a dental screw for osseointegration of a bone surface including a base including a first base surface, a second base surface opposite to the first base surface, side base surface between the first base surface and the second base surface, a hole disposed in the first base surface, a first engaging portion formed in the hole, and a plurality of penetrating bodies arranged along an edge of the second base surface, wherein the plurality of penetrating bodies may include a first piercing surface inclined at a first angle with respect to the second base surface in a first circumferential direction of the edge of the second base surface, a second piercing surface inclined at a second angle with respect to the second base surface in a second circumferential direction of the edge of the second base surface, the second circumferential direction being opposite to the first circumferential direction, a plurality of side piercing surfaces between the first piercing surface and the second piercing surface, and a tip formed as the first piercing surface, the second piercing surface, and the plurality of side piercing surfaces meet, and wherein the second angle may be greater than the first angle.

In an embodiment, an area of the first piercing surface may be greater than an area of the second piercing surface.

In an embodiment, the first angle may range from 25 to 65 degrees, and the second angle may range from 70 to 110 degrees.

In an embodiment, the first engaging portion may include a screw thread.

In an embodiment, the plurality of penetrating bodies may be connected to each other without being separated from each other.

In an embodiment, the side base surface may include a plurality of side surfaces.

In an embodiment, the dental screw may further include an anchor including a first anchor surface, a second anchor surface opposite to the first anchor surface, a side anchor surface positioned between the first anchor surface and the second anchor surface and facing at least a portion of the hole, a second engaging portion formed on the side anchor surface and configured to engage with the first engaging portion, and a head disposed on the first anchor surface, wherein a maximum width or maximum diameter of the side anchor surface may be less than a maximum width or maximum diameter of the head.

In an embodiment, the first engaging portion and the second engaging portion may each include a screw thread.

In an embodiment, the hole may penetrate the first base surface and the second base surface.

In an embodiment, the base may further include a depression formed inside the edge of the second base surface.

According to embodiments, a dental screw may be stably maintained on a bone surface. According to embodiments, the dental screw may reduce the foreign sensation felt by a subject. The effects of the dental screw are not limited to the above-mentioned effects, and other unmentioned effects may be clearly understood from the following description by one of ordinary skill in the art to which the present disclosure pertains.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates an orthodontic appliance according to an embodiment;

FIG. 2 is a perspective view of a dental screw according to an embodiment;

FIG. 3 is an exploded perspective view of a dental screw according to an embodiment;

FIG. 4 is a perspective view of a base according to an embodiment;

FIG. 5 is a plan view of a base according to an embodiment;

FIG. 6 is a bottom view of a base according to an embodiment;

FIG. 7 is a cross-sectional view of the base of FIG. 6, taken along a line 7-7 according to an embodiment;

FIG. 8 is a perspective view of an anchor viewed in one direction according to an embodiment; and

FIG. 9 is a perspective view of an anchor viewed in another direction according to an embodiment.

### DETAILED DESCRIPTION

Hereinafter, embodiments will be described in detail with reference to the accompanying drawings. However, various alterations and modifications may be made to the embodiments. Here, the embodiments are not construed as limited to the disclosure. The embodiments should be understood to include all changes, equivalents, and replacements within the idea and the technical scope of the disclosure.

The terminology used herein is for the purpose of describing particular embodiments only and is not to be limiting to the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, components, and/or combinations thereof but do not preclude the presence or addition of one or more other features, integers, steps, operations, elements, components and/or combinations thereof.

Unless otherwise defined, all terms including technical and scientific terms used herein have the same meaning as commonly understood by one of ordinary skill in the art to which embodiments belong. Terms, such as those defined in commonly used dictionaries, are to be interpreted as having a meaning consistent with their meaning in the context of the relevant art and the present disclosure and are not to be interpreted in an idealized or overly formal sense unless expressly so defined herein.

When describing the embodiments with reference to the accompanying drawings, like reference numerals refer to like components and a repeated description related thereto will be omitted. When describing the embodiments, a detailed description of well-known related technologies will be omitted when it is deemed that such a description will cause an ambiguous interpretation of the present disclosure.

In addition, terms such as first, second, A, B, (a), (b), and the like may be used to describe components of the embodiments. These terms are used only for the purpose of distinguishing one component from another component, and the nature, sequences, or orders of the components are not limited by the terms. It is to be understood that if a component is described as being “connected,” “coupled” or “joined” to another component, the former may be directly “connected,” “coupled,” and “joined” to the latter or “connected”, “coupled”, and “joined” to the latter via another component.

Components included in an embodiment and components having a common function are described using the same names in other embodiments. Unless stated otherwise, the description of an embodiment may be applicable to other embodiments, and a repeated description related thereto is omitted.

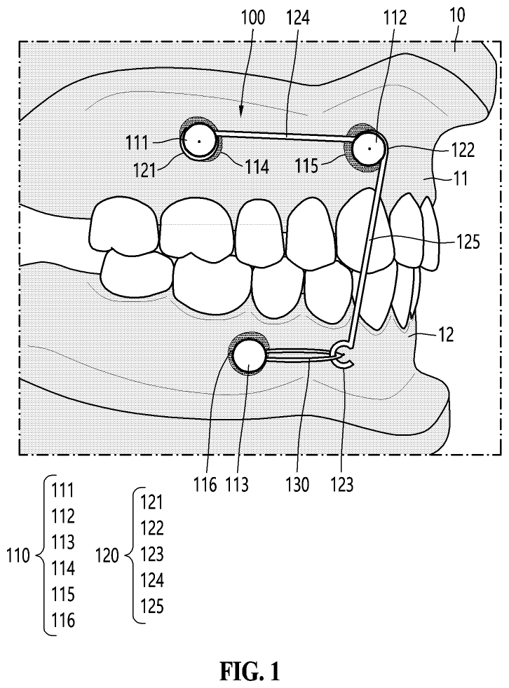

FIG. 1 illustrates an orthodontic appliance according to an embodiment.

Referring to FIG. 1, an orthodontic appliance 100 may be configured to treat or correct sleep apnea of a subject 10. In an oral structure to which the orthodontic appliance 100 is applied, an impact provided to a surrounding tooth (teeth) may be reduced. When applied to the subject 10, the orthodontic appliance 100 may reduce or eliminate a sense of difference that a user may feel. Once applied to the subject 10, the orthodontic appliance 100 may be used semi-permanently.

In an embodiment, the orthodontic appliance 100 may include a fixed portion 110 configured to be fixed to the subject 10. The fixed portion 110 may include a first dental implant 111 configured to be fixed to a first portion of a first jawbone 11 (e.g., a maxilla) of the subject 10. The fixed portion 110 may include a second dental implant 112 configured to be fixed to a second portion of the first jawbone 11, the second portion being different from the first portion of the first jawbone 11 of the subject 10. The fixed portion 110 may include a third dental implant 113 configured to be fixed to a second jawbone 12 (e.g., a mandible) of the subject 10. The first portion and the second portion of the first jawbone 11 may be spaced apart from each other in an arrangement direction of teeth on the first jawbone 11.

In an embodiment, the orthodontic appliance 100 may include a first bonding portion 114 configured to bond the first dental implant 111 to the first portion (e.g., a tissue surface) of the first jawbone 11. The orthodontic appliance 100 may include a second bonding portion 115 configured to bond the second dental implant 112 to the second portion (e.g., a tissue surface) of the first jawbone 11. The orthodontic appliance 100 may include a third bonding portion 116 configured to bond the third dental implant 113 to a portion (e.g., a tissue surface) of the second jawbone 12.

In an embodiment, the orthodontic appliance 100 may include a connecting portion 120 configured to connect a plurality of dental implants (e.g., 111, 112, and 113) to one another. The connecting portion 120 may include a first hoop 121 configured to engage with the first dental implant 111. The first hoop 121 may be disposed on the first jawbone 11. The connecting portion 120 may include a second hoop 122 configured to engage with the second dental implant 112. The second hoop 122 may be disposed on the first jawbone 11. The connecting portion 120 may include a third hoop 123. The third hoop 123 may be disposed on the second jawbone 12. The connecting portion 120 may include a first bar 124 connected to the first hoop 121 and the second hoop 122. The connecting portion 120 may include a second bar 125 connected to the second hoop 122 and the third hoop 123.

In an embodiment, the orthodontic appliance 100 may include a traction portion 130 configured to apply traction to the second jawbone 12. The traction portion 130 may be configured to apply traction to the third hoop 123 toward the third dental implant 113. The traction portion 130 may elastically deform. The traction portion 130 may form a closed loop.

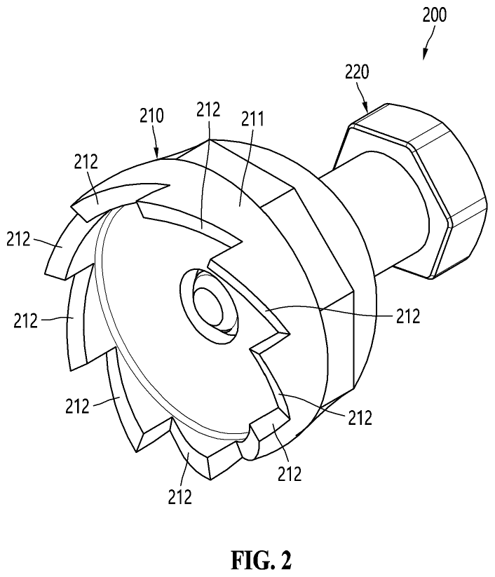

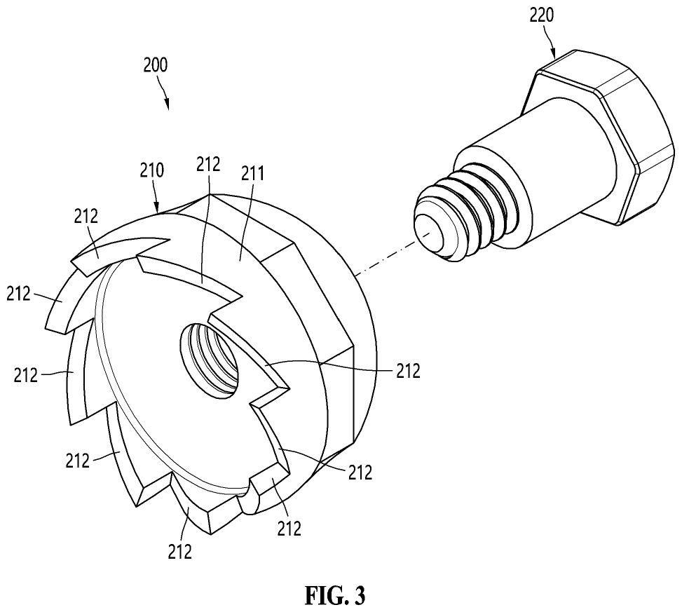

FIG. 2 is a perspective view of a dental screw according to an embodiment. FIG. 3 is an exploded perspective view of the dental screw according to an embodiment.

Referring to FIGS. 2 and 3, a dental screw 200 (e.g., the first dental implant 111, the second dental implant 112, and/or the third dental implant 113 of FIG. 1) may include a base 210. The base 210 may include a base body 211. The base body 211 may be disposed on or above a surface of an oral structure (e.g., the first jawbone 11 and/or the second jawbone 12 of FIG. 1) of a subject (e.g., the subject 10 of FIG. 1).

The base 210 may include a plurality (e.g., nine) of penetrating bodies 212. The plurality of penetrating bodies 212 may be configured to penetrate the oral structure (e.g., the first jawbone 11 and/or the second jawbone 12) of the subject (e.g., the subject 10 of FIG. 1). A biological substance (e.g., blood) generated from the oral structure when the plurality of penetrating bodies 212 penetrates into the oral structure may flow between the oral structure and the base body 211. The base body 211 may be bonded (e.g., adhered) to the surface of the oral structure by the biological substance.

The plurality of penetrating bodies 212 may be configured to be fixed in the oral structure (e.g., the first jawbone 11 and/or the second jawbone 12) of the subject (e.g., the subject 10 of FIG. 1). The plurality of penetrating bodies 212 may be configured in a way that the plurality of penetrating bodies 212 is not easily removed from the oral structure. The base body 211 may be stably maintained on or above the surface of the oral structure.

The dental screw 200 may include an anchor 220. The anchor 220 may be configured to engage with a hoop (e.g., the first hoop 121, the second hoop 122, and/or the third hoop 123 of FIG. 1). The anchor 220 may be configured to be coupled to the base 210. For example, the anchor 220 and a screw thread of the base 210 may be coupled to each other by engagement.

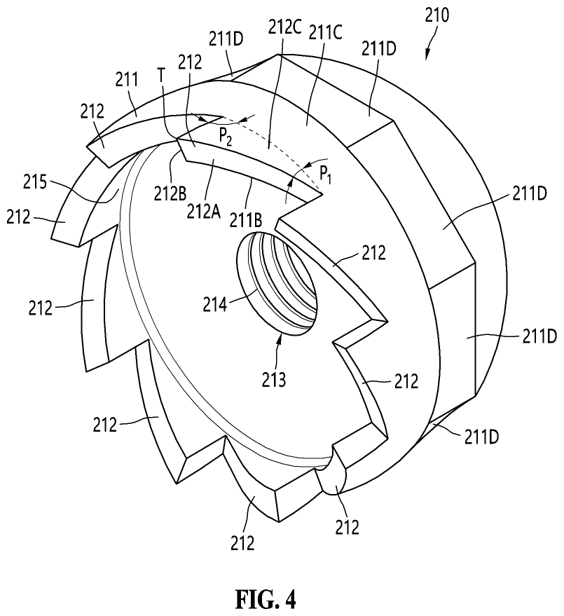

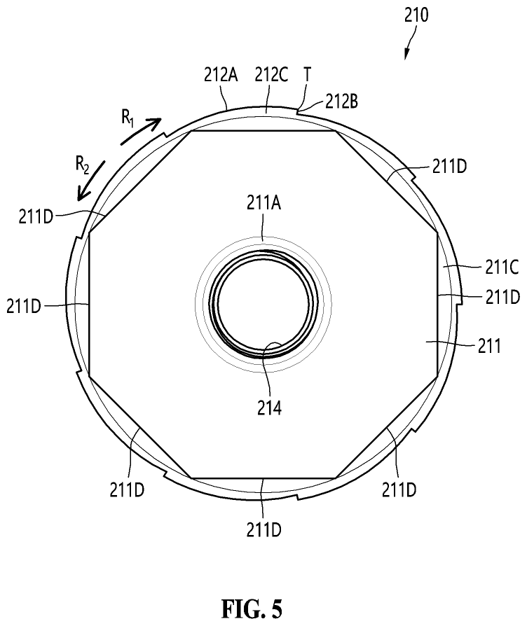

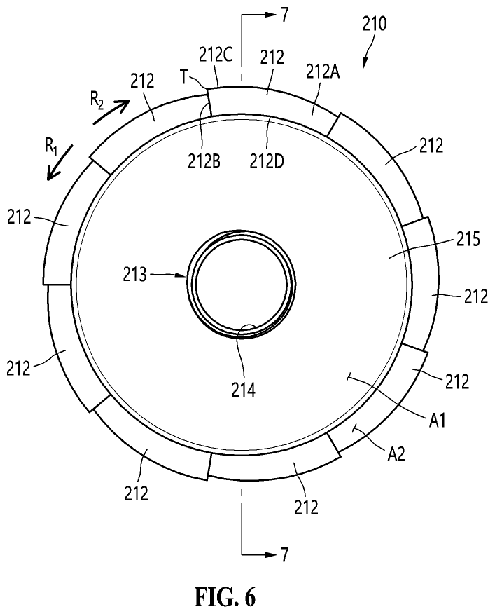

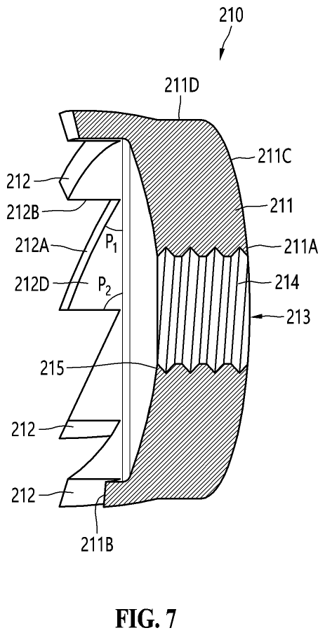

FIG. 4 is a perspective view of a base according to an embodiment. FIG. 5 is a plan view of the base according to an embodiment. FIG. 6 is a bottom view of the base according to an embodiment. FIG. 7 is a cross-sectional view of the base of FIG. 6, taken along a line 7-7 according to an embodiment.

Referring to FIGS. 4 to 7, the base 210 may include the base body 211. The base body 211 may include a first base surface 211A (e.g., a front base surface), a second base surface 211B (e.g., a rear base surface) opposite to the first base surface 211A, and a side base surface 211C between the first base surface 211A and the second base surface 211B.

The diameter or width of the first base surface 211A may be less than the diameter or width of the second base surface 211B. In an embodiment not shown, the diameter or width of the first base surface 211A may be substantially the same as the diameter or width of the second base surface 211B. In an embodiment not shown, the diameter or width of the first base surface 211A may be greater than the diameter or width of the second base surface 211B.

The side base surface 211C may include a plurality of side surfaces 211D. For example, the side base surface 211C may include surfaces (e.g., flat surfaces) having a substantially linear profile. The plurality of side surfaces 211D of the side base surface 211C may be connected in a circumferential direction to have a substantially regular polygonal shape (e.g., a regular octagonal shape in FIG. 5). In this structure, when a tool (e.g., an octagonal wrench) is applied to the side base surface 211C, the base 210 may rotate with respect to a subject (e.g., the subject 10 of FIG. 1). A user (e.g., a dentist) may place the base 210 on a desired part of the subject, primarily rotate and fix the base 210 into the desired part of the subject using a primary tool (e.g., the anchor 220), and more firmly fix the base 210, which is at least partially within the part, using a secondary tool (e.g., an octagonal wrench). The side base surface 211C may include a curved surface connected to the first base surface 211A. In this structure, the foreign body sensation felt by the subject 10 may be reduced.

The base 210 may include the plurality of penetrating bodies 212. The plurality of penetrating bodies 212 may be disposed on the second base surface 211B.

A penetrating body 212 may include a first piercing surface 212A. The first piercing surface 212A may be inclined at a first angle P₁ with respect to the second base surface 211B in a first circumferential direction R₁ (e.g., a counterclockwise direction in FIG. 6) of the second base surface 211B.

The penetrating body 212 may include a second piercing surface 212B. The second piercing surface 212B may be inclined at a second angle P₂ with respect to the second base surface 211B in a second circumferential direction R₂ (e.g., the clockwise direction in FIG. 6) of the second base surface 211B. The second circumferential direction R₂ may be opposite to the first circumferential direction R₁.

The size of the first angle P₁ may be less than the size of the second angle P₂. The first angle P₁ may be about 25 degrees or more, about 30 degrees or more, about 35 degrees or more, about 40 degrees or more, about 45 degrees or more, about 50 degrees or more, or about 55 degrees or more. The first angle P₁ may be about 65 degrees or less, about 60 degrees or less, about 55 degrees or less, about 50 degrees or less, or about 45 degrees or less. The second angle P₂ may be about 70 degrees or more, about 75 degrees or more, about 80 degrees or more, about 85 degrees or more, or about 90 degrees or more. The second angle P₂ may be about 110 degrees or less, about 105 degrees or less, about 100 degrees or less, or about 95 degrees or less. Herein, the term “about” or “substantially” may be defined with tolerance levels of ±1%, ±2%, ±5%, or ±10% around determined numerical values. Within these angle ranges, the plurality of penetrating bodies 212 may penetrate oral tissue (e.g., the first jawbone 11 and/or the second jawbone 12 of FIG. 1) of a subject (e.g., the subject 10 of FIG. 1) with less force while rotating in the first circumferential direction R₁. The plurality of penetrating bodies 212 may not be easily removed after adhering to the oral tissue of the subject. For example, a structure in which the second angle P₂ is relatively greater than the first angle P₁ may allow the plurality of penetrating bodies 212 to penetrate the oral tissue when the base 210 rotates in the first circumferential direction R₁ and may prevent the plurality of penetrating bodies 212 from being removed from the oral tissue when the base 210 rotates in the second circumferential direction R₂.

The area of the first piercing surface 212A may be greater than the area of the second piercing surface 212B.

The first piercing surface 212A may be inclined in a radially outward direction with respect to the second base surface 211B. The second piercing surface 212B may be inclined in a radially outward direction with respect to the second base surface 211B. The projection of a tip T may partially overlap an edge of the second base surface 211B or may be offset from the edge of the second base surface 211B when viewed in a direction from the second base surface 211B toward the first base surface 211A.

The penetrating body 212 may include an outer side piercing surface 212C. The outer side piercing surface 212C may be between the first piercing surface 212A and the second piercing surface 212B. The outer side piercing surface 212C may be oriented in the outward direction (e.g., a radially outward direction in FIG. 6) of the second base surface 211B. The outer side piercing surface 212C may be connected to the side base surface 211C, for example, monolithically. The side piercing surface 212C may include a curved surface.

The penetrating body 212 may include an inner side piercing surface 212D. The inner side piercing surface 212D may be between the first piercing surface 212A and the second piercing surface 212B. The inner side piercing surface 212D may be oriented in the inner direction (e.g., the radially inner direction in FIG. 6) of the second base surface 211B. The inner side piercing surface 212D may be opposite to the outer side piercing surface 212C. The inner side piercing surface 212D may be connected to the second base surface 211B, for example, monolithically. The inner side piercing surface 212D may include a curved surface.

The penetrating body 212 may include the tip T. The first piercing surface 212A, the second piercing surface 212B, the outer side piercing surface 212C, and the inner side piercing surface 212D may meet to form the tip T. The tip T may be implemented as an edge between the first piercing surface 212A and the second piercing surface 212B. The tip T may extend in a radial direction with respect to the second base surface 211B. In an embodiment, the tip T may be substantially parallel to at least a portion of the second base surface 211B. In an embodiment, the tip T may be inclined in a radial direction with respect to the second base surface 211B. As the plurality of penetrating bodies 212 first starts penetrating the oral tissue of the subject, an area in which the plurality of penetrating bodies 212 contacts the oral tissue may be reduced, allowing the plurality of penetrating bodies 212 to penetrate the oral tissue with relatively less force.

The distance between the projection of the tip T on the second base surface 211B and a portion in which the first piercing surface 212A meets the second base surface 211B may be less than the distance between the projection of the tip T on the second base surface 211B and a portion in which the second piercing surface 212B meets the second base surface 211B. This may prevent the plurality of penetrating bodies 212 from easily being removed by an external force when the plurality of penetrating bodies 212 penetrate and is inserted into the oral tissue of the subject. Accordingly, the base body 211 may be stably maintained on the surface of the oral tissue.

The plurality of penetrating bodies 212 may be arranged in the circumferential direction of the second base surface 211B along the edge of the second base surface 211B. In an embodiment, the plurality of penetrating bodies 212 may be directly connected to each other without being spaced apart from each other. For example, the first piercing surface 212B of one penetrating body 212 of a pair of adjacent penetrating bodies 212 may be directly connected to the second piercing surface 212B of the other penetrating body 212. In an embodiment, the plurality of penetrating bodies 212 may be spaced apart from each other. For example, the distance between a pair of adjacent penetrating bodies 212 may be substantially the same as the distance between another pair of adjacent penetrating bodies 212.

The base 210 may include a hole 213. The hole 213 may include a substantially circular shape. The hole 213 may penetrate the first base surface 211A and the second base surface 211B.

The base 210 may include a first engaging portion 214. The first engaging portion 214 may be positioned on a side of the hole 213. The first engaging portion 214 may include a screw thread.

The base 210 may include a depression 215. The depression 215 may be disposed on the second base surface 211B in a direction toward the first base surface 211A. The depression 215 may include a substantially curved surface. The depression 215 may form an edge region A2 different from a central region A1. The plurality of penetrating bodies 212 may be disposed in the edge region A2. The plurality of penetrating bodies 212 may not be disposed in the central region A1.

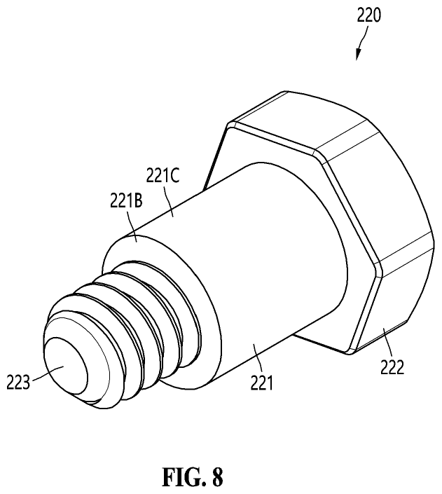

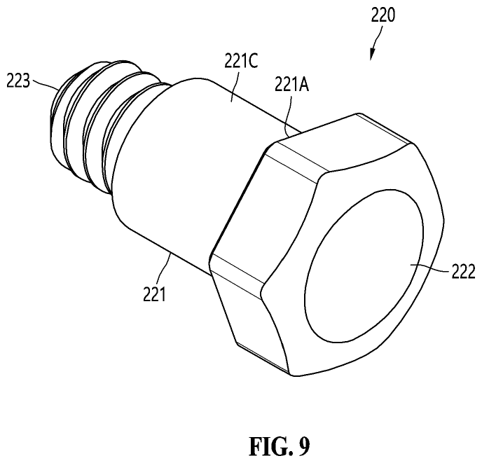

FIG. 8 is a perspective view of an anchor viewed in one direction according to an embodiment. FIG. 9 is a perspective view of an anchor viewed in another direction according to an embodiment.

Referring to FIGS. 8 and 9, the anchor 220 may include an anchor body 221. The anchor body 221 may include a first anchor surface 221A (e.g., a front anchor surface), a second anchor surface 221B (e.g., a rear anchor surface) opposite to the first anchor surface 221A, and a side anchor surface 221C between the first anchor surface 221A and the second anchor surface 221B. The anchor body 221 may include a substantially cylindrical shape. In an embodiment not shown, the side anchor surface 221C may have a polygonal shape. For example, the side anchor surface 221C may be configured to engage with a hoop (e.g., the first hoop 121, the second hoop 122, and/or the third hoop 123 of FIG. 1).

The anchor 220 may include an anchor head 222. The anchor head 222 may protrude from the first anchor surface 221A. In an embodiment, the anchor head 222 may have a polygonal shape. In an embodiment not shown, the anchor head 222 may be circular.

The maximum width or maximum diameter of the anchor head 222 may be greater than the maximum width or maximum diameter of the side anchor surface 221C. The protrusion length of the anchor head 222 may be less than the length of the side anchor surface 221C. In an embodiment not shown, the protrusion length of the anchor head 222 may be greater than the length of the side anchor surface 221C.

The anchor 220 may include a second engaging portion 223. The second engaging portion 223 may protrude from the second anchor surface 221B. The second engaging portion 223 may be configured to engage with a first engaging portion (e.g., the first engaging portion 214 of FIGS. 2 to 7) of a hole (e.g., the hole 213 of FIGS. 2 to 7). For example, the second engaging portion 223 may include a screw thread matching a screw thread of the first engaging portion 214.

The protrusion length of the second engaging portion 223 may be substantially the same as the depth of the hole (e.g., the hole 213 of FIGS. 4 to 7). The protrusion length of the second engaging portion 223 may be greater than the depth of the hole (e.g., the hole 213 of FIGS. 4 to 7). For example, when the anchor 220 is coupled to a base (e.g., the base 210 of FIGS. 4 to 7) through the engagement of the first engaging portion 214 and the second engaging portion 223, an end of the second engaging portion 223 may protrude from one surface of a second base surface (e.g., the second base surface 211B of FIGS. 4 to 7).

Although the embodiments have been described with reference to the limited drawings, one of ordinary skill in the art may apply various technical modifications and variations based thereon. For example, suitable results may be achieved if the described techniques are performed in a different order and/or if components in a described system, architecture, device, or circuit are combined in a different manner or replaced or supplemented by other components or their equivalents.

Therefore, other implementations, other embodiments, and equivalents of the claims are within the scope of the following claims.

What is claimed is:

1. A dental screw for osseointegration of a bone surface, the dental screw comprising:
a base comprising:
a first base surface;
a second base surface opposite to the first base surface;
a side base surface between the first base surface and the second base surface;
a hole disposed in the first base surface;
a first engaging portion formed in the hole; and
a plurality of penetrating bodies arranged along an edge of the second base surface,
wherein the plurality of penetrating bodies comprises:
a first piercing surface inclined at a first angle with respect to the second base surface in a first circumferential direction of the edge of the second base surface;
a second piercing surface inclined at a second angle with respect to the second base surface in a second circumferential direction of the edge of the second base surface, the second circumferential direction being opposite to the first circumferential direction;
a plurality of side piercing surfaces between the first piercing surface and the second piercing surface, and
a tip formed as the first piercing surface, the second piercing surface, and the plurality of side piercing surfaces meet, and
wherein the second angle is greater than the first angle.

2. The dental screw of claim 1, wherein an area of the first piercing surface is greater than an area of the second piercing surface.

3. The dental screw of claim 1, wherein the first angle ranges from 25 to 65 degrees, and the second angle ranges from 70 to 110 degrees.

4. The dental screw of claim 1, wherein the first engaging portion comprises a screw thread.

5. The dental screw of claim 1, wherein the plurality of penetrating bodies is connected to each other without being spaced apart from each other.

6. The dental screw of claim 1, wherein the side base surface comprises a plurality of side surfaces.

7. The dental screw of claim 1, further comprising:
an anchor comprising:
a first anchor surface;
a second anchor surface opposite to the first anchor surface;
a side anchor surface positioned between the first anchor surface and the second anchor surface and facing at least a portion of the hole;
a second engaging portion formed on the side anchor surface and configured to engage with the first engaging portion; and
a head disposed on the first anchor surface,
wherein a maximum width or maximum diameter of the side anchor surface is less than a maximum width or diameter of the head.

8. The dental screw of claim 7, wherein the first engaging portion and the second engaging portion each comprise a screw thread.

9. The dental screw of claim 1, wherein the hole is configured to penetrate the first base surface and the second base surface.

10. The dental screw of claim 1, wherein the base further comprises a depression formed inside the edge of the second base surface.
